(19) United States
(12) Patent Application Publication
(10) Pub. No.: US 2023/0036180 A1
(43) Pub. Date: Feb. 2, 2023

(54) MACHINING APPARATUS

(71) Applicant: VERO VERIA CORPORATION, New Taipei City (TW)

(72) Inventor: Chien-Teh Huang, New Taipei City (TW)

(21) Appl. No.: 17/666,614

(22) Filed: Feb. 8, 2022

(30) Foreign Application Priority Data
Jul. 27, 2021 (TW) 110127470
Jul. 27, 2021 (TW) 110208801

(51) Int. Cl. B23C 3/12

(52) U.S. Cl. CPC B23C 3/12

(57) ABSTRACT

A machining apparatus integrates a height milling device, an edge milling device and a hole forming device into a production line. As such, on the single production line, a height milling machining, an edge milling machining, a hole forming machining and so on can be performed on foot bases of a target object, such as an elevated floor, thereby speeding up the production and improving the production efficiency.

### BACKGROUND

### 1. Technical Field

The present disclosure relates to machining apparatuses, and more particularly, to a multi-functional machining apparatus.

### 2. Description of Related Art

Nowadays, elevated floor devices are widely applied in anti-static machine rooms or clean rooms. Generally, elevated floors by die casting of aluminum alloy go through five main processes, which include moldmaking, aluminum melting, die casting, molding and trimming However, during the molding process, many burrs occur on the surface and bottom of the elevated floors, which not only adversely affect tight attachment between the elevated floors and between the elevated floors and a platform frame, but also are not conducive to installation and bring some safety concerns for workers.

Conventionally, after the molding process, the burrs on four foot bases and four side surfaces of an elevated floor must be removed manually and then a plurality of positioning holes are formed on a surface of the elevated floor. Therefore, batches of elevated floors must be transported to a machining place for machining, which not only results in a low production efficiency due to a discontinuous production process, but also is labor and time consuming

Therefore, how to overcome the above-described drawbacks of the prior art has become an urgent issue in the art.

### SUMMARY

In view of the above-described drawbacks of the prior art, the present disclosure provides a machining apparatus, which comprises: a transport device for moving a target object, wherein the target object has a first surface, a second surface opposite to the first surface, a side surface adjacent to and connecting the first surface and the second surface, and a flange protruding from the side surface, and four corners of the second surface have four foot bases; a height milling device actuating in cooperation with the transport device for machining end surfaces of the foot bases of the target object, wherein the height milling device comprises a height milling component comprising at least one first milling tool, a first motor directly driving the first milling tool, at least one first support structure having sliding rails disposed on surfaces of two opposite sides thereof, at least one carrying frame symmetrically disposed on the two opposite sides of the first support structure, and at least one adjustment member, wherein the first motor and the first milling tool are disposed on one side of the carrying frame and a sliding base engaged with the sliding rails is disposed on another side of the carrying frame, wherein the adjustment member drives the first milling tool on the carrying frame to move linearly up and down along the sliding rails to reach a height required to process the foot bases, and wherein the first motor and the first milling tool are integrated in a linear manner; an edge milling device actuating in cooperation with the transport device for machining the flange of the target object, wherein the edge milling device comprises an edge milling component comprising a second milling tool, a second support structure for driving the second milling tool to displace linearly, a frame base displaceably disposed on the second support structure for carrying the second milling tool, and a second motor disposed on the frame base for directly driving the second milling tool to cause the frame base and the second milling tool to move close to or away from the target object, thereby allowing the second milling tool to perform an edge milling machining on the target object, wherein the second support structure is a plate base body, and wherein the second motor and the second milling tool are integrated in a linear manner; and a hole forming device for forming holes on the four foot bases of the target object, wherein the hole forming device comprises at least one hole forming member for performing a hole forming machining on the target object, and at least one third motor for rotating the hole forming component, and wherein the third motor and the hole forming member are integrated in a linear manner.

In the aforementioned machining apparatus, the transport device comprises a support component and at least one picking and placing component displaceably disposed on the support component and cooperating with the support component to move the target object, thereby picking an placing the target object.

In the aforementioned machining apparatus, the carrying frame is an L-shaped frame body symmetrically disposed on the two opposite sides of the first support structure, wherein the first milling tool and the first motor are disposed on the side of the carrying frame facing the target object in a manner that the first milling tool on the carrying frame moves linearly up and down along the sliding rails.

In the aforementioned machining apparatus, the height milling device further comprises: a first base platform for disposing the height milling component; a first positioning member disposed on and in parallel to the first base platform for carrying the target object and limiting displacement of the target object; a fastening portion correspondingly disposed at two opposite sides of the first positioning member for pressing the target object on the first positioning member; and a driving member for driving the first support structure to displace, thereby driving the height milling component to move linearly to perform a height milling machining on the target object.

In the aforementioned machining apparatus, the second support structure has a displacement direction perpendicular to a displacement direction of the frame base.

In the aforementioned machining apparatus, the second support structure has a rail, and the frame base has at least one sliding block cooperated with the rail, and wherein the sliding block moves along the rail to cause the frame base to displace relative to the second support structure.

In the aforementioned machining apparatus, the edge milling device further comprises: a second base platform for displaceably disposing the edge milling component thereon, wherein the second support structure is displaceably disposed on the second base platform; a second positioning member disposed on the second base platform for placing the target object, wherein the edge milling component is disposed at a side of the second positioning member to displace relative to the second positioning member and perform the edge milling machining on the target object; and a fastening portion disposed corresponding to the second positioning member for pressing the target object on the second positioning member.

In the aforementioned machining apparatus, the hole forming member is of a step drill type.

In the aforementioned machining apparatus, the hole forming device further comprises: a base platform defined with a machining area and a discharging area, wherein the hole forming member is displaceably disposed on the machining area to perform a hole forming machining on the foot bases of the target object, thereby completing drilling operation of counterbored holes required at the foot bases of the target object; a positioning member disposed on the machining area of the base platform for limiting the target object in the machining area; and a fastening structure arranged corresponding to the positioning member to contact and abut against the target object on the base platform.

In the aforementioned machining apparatus, the machining apparatus further comprises a flipping device disposed between the edge milling device and the hole forming device for flipping the first surface or the second surface of the target object, wherein the flipping device comprises a base platform, a shaft structure disposed on the base platform, a positioning member disposed on the base platform, a third support structure displaceably disposed on the base platform, and a driving member disposed on the base platform, and wherein one end of the positioning member is pivotally connected to the shaft structure to flip relative to the base platform, and the driving member drives the positioning member, such that the positioning member flips under force over the third support structure.

In summary, in the machining apparatus according to the present disclosure, the height milling device, the edge milling device and the hole forming device are integrated on a production line, and the first to third motors (e.g., servo motors) are used to actuate the first milling tool, the second milling tool and the hole forming member, respectively. As such, on the single production line, a height milling machining, an edge milling machining, a hole forming machining and so on can be performed on foot bases of an elevated floor, thus speeding up the production, improving the production efficiency and reducing the labor cost.

### BRIEF DESCRIPTION OF DRAWINGS

FIG. 1A-1 is a schematic front perspective view of a machining apparatus according to the present disclosure.

FIG. 1A-2 is a schematic rear perspective view of the machining apparatus according to the present disclosure.

FIG. 1A-3 is a schematic perspective view of a transport device of the machining apparatus according to the present disclosure.

FIG. 1B is a schematic partially-enlarged perspective view of position B of FIG. 1A-3.

FIG. 1C-1 is a schematic top perspective view of a target object to be processed by the machining apparatus according to the present disclosure.

FIG. 1C-2 is a schematic bottom perspective view of FIG. 1C-1.

FIG. 1C-3 is a schematic side plan view of FIG. 1C-1.

FIG. 1D is a schematic side plan view of the target object that is already processed by the machining apparatus according to the present disclosure.

FIG. 2A is a schematic perspective view of a height milling device of the machining apparatus according to the present disclosure.

FIG. 2B is a schematic top plan view of another embodiment of FIG. 2A.

FIG. 2C is a schematic left plan view of FIG. 2B.

FIG. 3A is a schematic perspective view of an edge milling device of the machining apparatus according to the present disclosure.

FIG. 3B is a schematic top plan view of FIG. 3A.

FIG. 3C is a schematic side plan view of FIG. 3A.

FIG. 4A is a schematic exploded perspective view of a flipping device and a hole forming device of the machining apparatus according to the present disclosure.

FIG. 4B is a schematic partial perspective view of FIG. 4A from another viewpoint.

FIG. 5A is a schematic partial perspective view of FIG. 4A.

FIG. 5B is a schematic partially enlarged view of FIG. 5A.

### DETAILED DESCRIPTION

The following illustrative embodiments are provided to illustrate the present disclosure, these and other advantages and effects can be apparent to those in the art after reading this specification.

It should be noted that all the drawings are not intended to limit the present disclosure. Various modifications and variations can be made without departing from the spirit of the present disclosure. Further, terms such as “up,” “down,” “front,” “rear,” “left,” “right,” “a,” etc. are merely for illustrative purposes and should not be construed to limit the scope of the present disclosure.

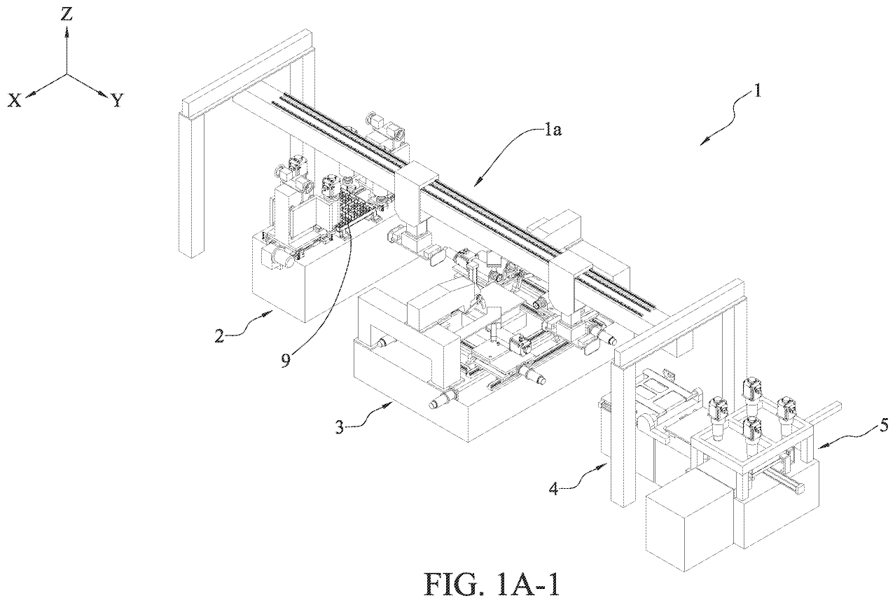

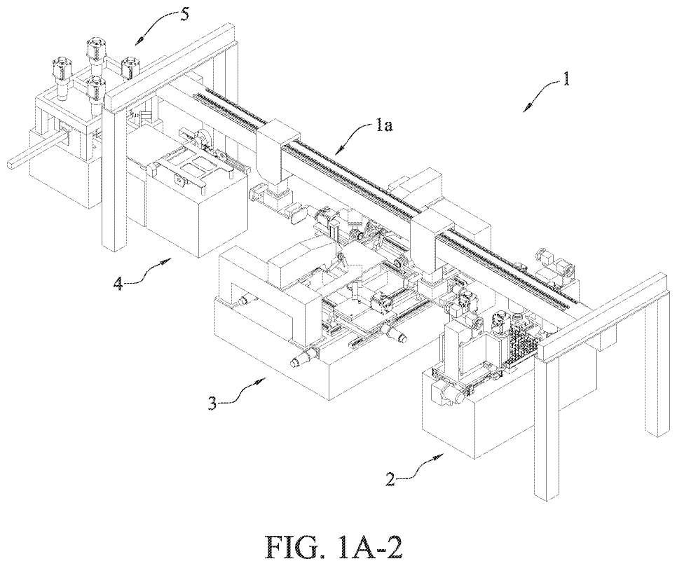

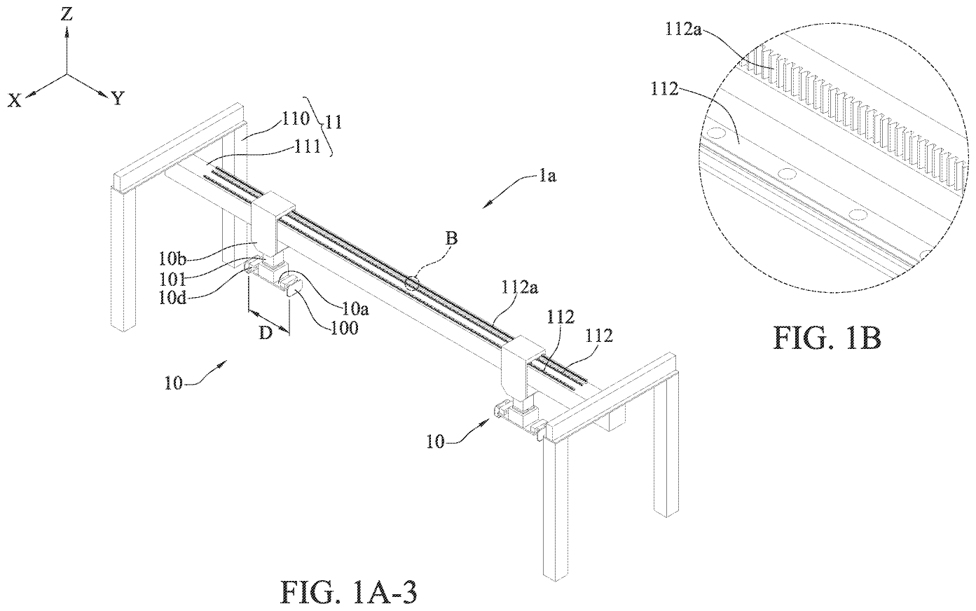

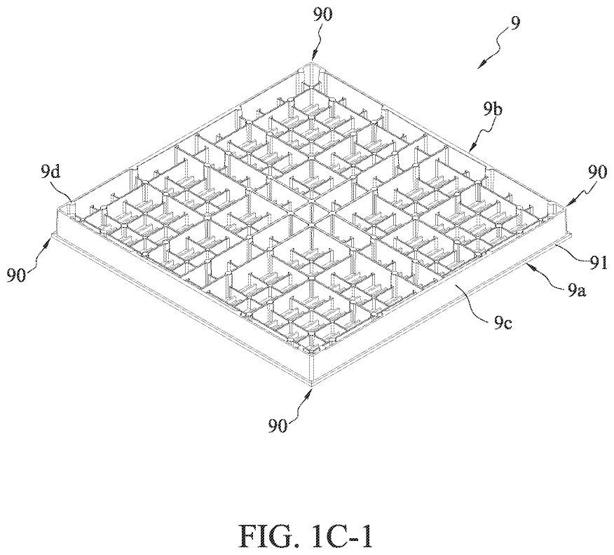

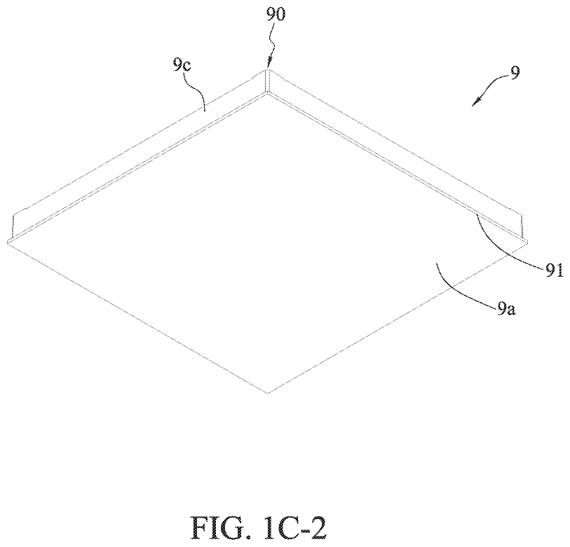

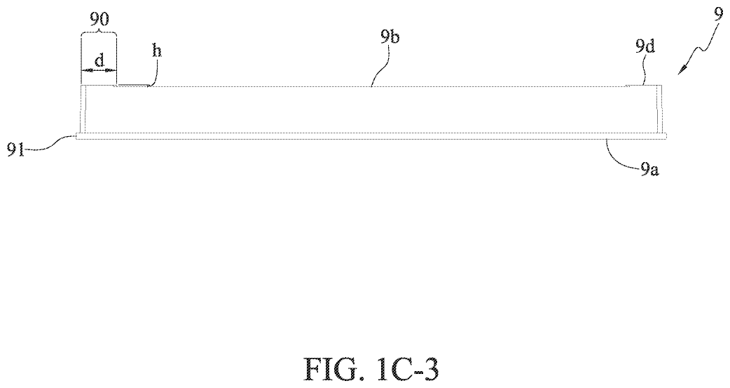

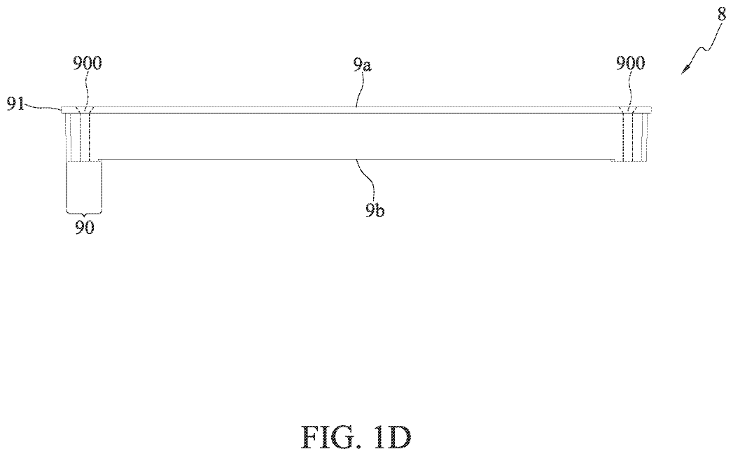

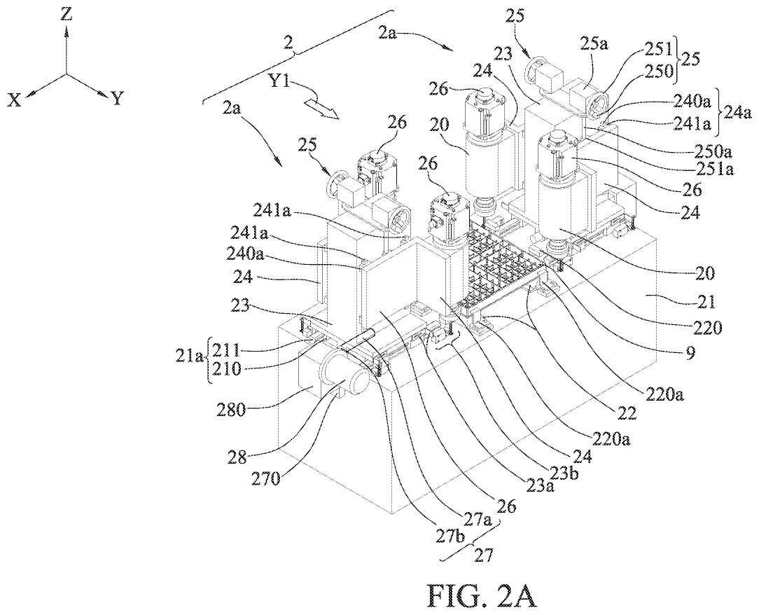

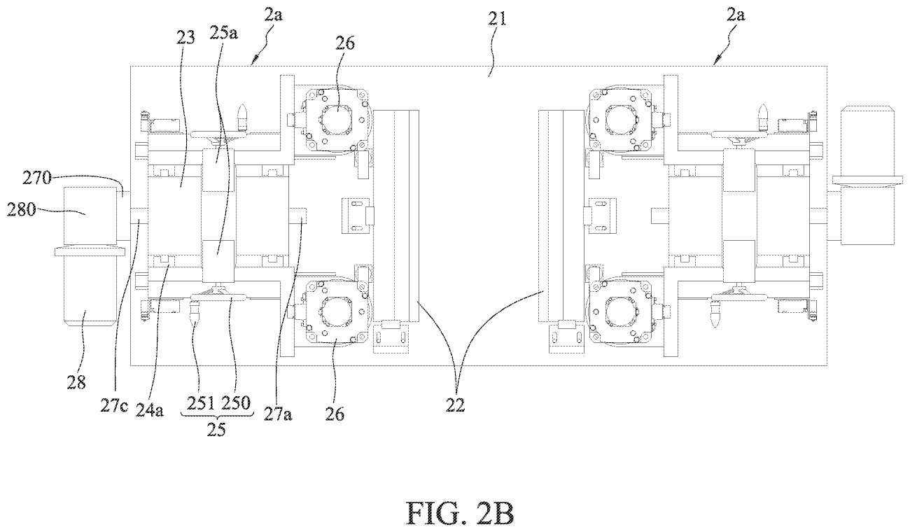

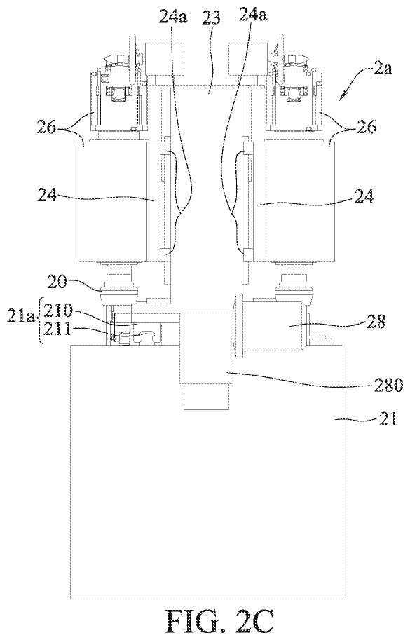

FIGS. 1A-1 and 1A-2 are schematic perspective views of a machining apparatus 1 according to the present disclosure. Referring to FIGS. 1A-1 and 1A-2, the machining apparatus 1 includes a transport device 1 a, a height milling device 2, an edge milling device 3, a flipping device 4 and a hole forming device 5.

In an embodiment, for the machining apparatus 1 and for purpose of illustration, the direction of the production line is defined as a left or right direction (e.g., an arrow direction Y), a direction perpendicular to the production line is defined as a front or rear direction (e.g., an arrow direction X), and the height direction along the machining apparatus 1 is defined as a top or bottom direction (e.g., an arrow direction Z). It should be understood that the aforementioned orientations are used to illustrate the arrangement of the embodiment, and the present disclosure is not limited thereto.

The transport device 1a is used to transport (e.g., grip) a target object 9 to a required machining position of the production line. To facilitate placing of the target object 9 on the height milling device 2, the edge milling device 3, the flipping device 4 and/or the hole forming device 5, the transport device 1a is disposed over the height milling device 2, the edge milling device 3, the flipping device 4 and the hole forming device 5.

In an embodiment, referring to FIG. 1A-3, the transport device 1a includes at least a picking and placing component 10 for picking and placing the target object 9, and a support component 11. The picking and placing component 10 is displaceably disposed on the support component 11 and cooperates with the support component 11 so as to move the target object 9, thereby picking an placing the target object 9. For example, the support component 11 is a frame structure, which has two sets of door-shaped rod frames 110 (e.g., opposite to each other) vertically disposed on a base surface (e.g., floor) and a beam 111 disposed across the rod frames 110. The beam 111 is positioned over the height milling device 2, the edge milling device 3 and the flipping device 4 to serve as a displacement path of the picking and placing component 10. It should be understood that the support component 11 can be of various types and not limited to the above.

Further, the picking and placing component 10 includes a gripping portion 10a with a holding member 100 and a carrying portion 10b for arranging the gripping portion 10a. For example, the width D of the holding member 100 of the gripping portion 10a can be adjusted according to the requirement so as to grip the target object 9 having a different width. A hydraulic or pneumatic cylinder (serving as a power source 10d) can be used to control the distance of the two gripping portions 10a so as to grip or loosen the target object 9. The carrying portion 10b is a movable frame, which is vertically disposed on the beam 111 (or a position limiter 112) and pivotally connected to a gear (not shown). The gear (not shown) is engaged with a rack 112a (as shown in FIG. 1B). A driving force causes the gear to move linearly on the rack 112a such that the picking and placing component 10 can move linearly back and forth in the arrow direction Y with a sliding base (e.g., the carrying portion 10b) and the sliding rail component (e.g., the position limiter 112 and the rack 112a and gear on the position limiter 112). For instance, the plurality of power sources 10d (e.g., the pneumatic or hydraulic cylinder of FIG. 1A-3) drive the gripping portion 10a to bring the holding member 100 to extend outward or retract inward (in the arrow direction Y), thus producing a loosening or holding action. Further, a retractable structure 101 connected to the gripping portion 10a is disposed on the bottom of the carrying portion 10b so as to lift or descend the gripping portion 10a. A motor (not shown) can be disposed over the carrying portion 10b so as to drive the carrying portion 10b to displace, thereby driving the gear to move linearly on the rack 112a.

Furthermore, the number of the picking and placing component 10 can be set according to needs. For example, the picking and placing components 10 are respectively arranged corresponding to machining positions of the height milling device 2, the edge milling device 3 and the flipping device 4 (as such, at least two sets of picking and placing components 10 are arranged). For instance, one picking and placing component 10 is arranged between the height milling device 2 and the edge milling device 3, and the other picking and placing component 10 is arranged between the edge milling device 3 and the flipping device 4. If needed, a plurality of picking and placing components 10 can be added between the rod frames 110 and the height milling device 2 to serve as intermediate transferring components of the target object 9. As such, the target object 9 can be continuously picked and placed at each machining position so as to complete machining processes of the entire production line.

In addition, referring to FIGS. 1C-1, 1C-2 and 1C-3, the target object 9 is an elevated floor, which has a first surface 9a (e.g., a floor surface), a second surface 9b (e.g., a bottom end) opposite to the first surface 9a, and a side surface 9c adjacent to and connecting the first surface 9a and the second surface 9b. For example, the target object 9 is a substantially rectangular body (e.g., a square plate), the bottom of the target object 9 (i.e., the second surface 9b, which is the bottom of the elevated floor) has a honeycomb shape, and four corners of the second surface 9b of the target object 9 have four foot bases 90. Referring to FIG. 1D, holes 900 can be formed in the four foot bases 90 so as to fasten the four foot bases 90 on support legs by using screws (the support legs are used by the elevated floor). For instance, end surfaces 9d of the foot bases 90 slightly protrude from the second surface 9b of the target object 9 (with a height difference h, as shown in FIG. 1C-3), and a flange 91 is formed at an edge of the first surface 9a and protrudes from the side surface 9c. The flange 91 is the four edges of the elevated floor to be processed by the edge milling device 3. Since the target object 9 of the embodiment is an elevated floor, it is referred to as elevated floor hereinafter.

The height milling device 2 is disposed at the earliest machining stage of the entire production line and actuates in cooperation with the transport device 1a to process the end surfaces 9d of the foot bases 90. For example, the height milling device 2 is used to remove the burrs on the end surfaces 9d of the four foot bases 90 of the elevated floor so as to process the elevated floor to a required height.

In an embodiment, referring to FIG. 2A, the height milling device 2 includes at least a height milling component 2a, a first base platform 21 for disposing the height milling component 2a, and a first positioning member 22 disposed at and in parallel to the center of the first base platform 21 for carrying the target object 9 and limiting the displacement of the target object 9. The height milling component 2a corresponds to the first positioning member 22 and rises and descends relative to the first positioning member 22 so as to adjust the height milling amount of the target object 9 (elevated floor). After the height milling amount is set, the height milling component 2a moves horizontally to process the foot bases 90 of the target object 9. After the height milling machining of the target object 9 is completed, the picking and placing component 10 moves the target object 9 away from the first positioning member 22. For example, the first positioning member 22 is a frame body (e.g., frames arranged in parallel to one another, as shown in FIG. 2B), and the height milling component 2a is disposed at opposite sides (e.g., front and rear sides) of the first positioning member 22. If needed, at least a fastening portion 220 (e.g., swing clamp cylinder) can be disposed outside of the opposite sides of the first positioning member 22. In operation, the swing clamp cylinder serves as the fastening portion 220 correspondingly disposed at the two opposite sides of the first positioning member 22 for pressing the target object 9 on the first positioning member 22. Therefore, the elevated floor is fastened on the first base platform 21, and at least a swing clamp cylinder is disposed at one side of the first positioning member 22 so as to limit the displacement of the elevated floor and avoid deviation of the elevated floor from the first positioning member 22 during a milling operation. Further, at least a stop portion 220a can be disposed at an outer side of the first positioning member 22 and at the other side perpendicular to the side where the swing clamp cylinder is arranged on the first positioning member 22. The stop portion 220a is used for blocking the side surface 9c of the elevated floor, thus facilitating an operator to place the target object 9 (e.g., in the arrow direction Y1) on the first positioning member 22. Alternatively, the target object 9 to be processed can be gripped by the picking and placing component 10 from a feeding position (beside a left rod frame 110, not shown) and placed at the machining position on the first positioning member 22.

Further, the height milling component 2a has at least a first milling tool 20, a first servo motor 26 (e.g., the first servo motor 26 may be used as a motor) actuating the first milling tool 20, at least a first support structure 23 displaceably disposed on the first base platform 21, a carrying frame 24 symmetrically disposed on left and right sides of the first support structure 23 for carrying the first milling tool 20, and at least an adjustment member 25. In an embodiment, two separate first support structures 23 and four separate carrying frames 24 are provided to form two machine units each comprising one separate first support structure 23 and two separate carrying frames 24. The two machine units are parallelly disposed at the two opposite sides of the first positioning member 22, and the two separate carrying frames 24 of each machine unit are fastened on the two opposite sides of the corresponding first support structure 23 such that the plurality of first milling tools 20 on the carrying frames 24 can be simultaneously driven by the same power unit 28 so as to rapidly process the foot bases 90 of the target object 9 to the required height. For example, each carrying frame 24 is an L-shaped frame body. The first servo motor 26 (as shown in FIG. 2A or 2B) and the first milling tool 20 are disposed on the side of the carrying frame 24 facing the target object 9, and the first milling tool 20 is actuated by the first servo motor 26. For instance, the first servo motor 26 drives the first milling tool 20 to rotate so as to process the foot bases 90 of the target object 9 to the required height.

The first support structure 23 is a base body, which has an adjustment member 25 disposed thereon. The adjustment member 25 has a rotating rod 250 and a rotating disc 251. The rotating rod 250 can be manually operated so as to rotate the rotating disc 251. As such, the adjustment member 25 rotates a speed reducer 25a, the speed reducer 25a further drives a screw rod 250a to rotate, and the screw rod 250a further drives a nut 251a to move up and down. Since the nut 251a is fastened on the carrying frame 24, the screw rod 250a can drive the carrying frame 24 to rise and descend (e.g., in the arrow direction Z), thereby displacing the first milling tool 20 to the required height position. For example, the carrying frame 24 can be displaced via a guiding structure 24a. The guiding structure 24a includes a sliding rail 240a and a sliding base 241a engaged with the sliding rail 240a. The sliding rail 240a is fastened on two opposite surfaces of the first support structure 23, and the sliding base 241a is fastened on another end side of the carrying frame 24. When the rotating rod 250 rotates the rotating disc 251, the first milling tool 20 on the carrying frame 24 is moved linearly up and down (e.g., in the arrow direction Z) along the sliding rail 240a. Further, the first milling tool 20 can be adjusted to the height required to process the foot bases 90 according to the scale on a numerical instrument of the adjustment member 25. For instance, the numerical instrument (not shown) can be disposed on the rotating disc 251 of the adjustment member 25 to clearly control the height position of the carrying frame 24, thus allowing the first milling tool 20 to mill the four foot bases 90 of the target object 9 to the required height, for example, from a height of 56 mm before milling to a height of 55 mm after milling.

Further, according to the requirement, a driving member 27 can be disposed on the first base platform 21 for driving the first support structure 23 to displace, and a power unit 28 is disposed on the first base platform 21 for actuating the driving member 27, thereby driving the height milling component 2a to move linearly and perform a height milling machining on the target object 9. For example, the power unit 28 is a motor, which is fastened on a side surface of the first base platform 21 via a speed reducer 280. The driving member 27 includes a ball screw rod 27a, a bearing 27c (as shown in FIG. 2B) and a nut 27b. The bearing 27c is disposed on a bearing base 270, and the nut 27b is fastened on the bottom of the first support structure 23. When the power unit 28 drives the speed reducer 280 to rotate the ball screw rod 27a, the ball screw rod 27a can drive the first support structure 23 on the nut 27b to move linearly back and forth for a certain distance. The distance is greater than or equal to the width d of the foot bases 90 (as shown in FIG. 1C-3). As such, the ball screw rod 27a drives the first support structure 23 to move close to or away from the first positioning member 22. Furthermore, at least a baffle 23a can be disposed on a side of the first support structure 23, and at least a limiter 23b can be disposed on the first base platform 21. The machining stroke of the first milling tool 20 can be controlled by the position where the baffle 23a contacts the limiter 23b. Referring to FIG. 2C, in order to provide a combination 21a of a guiding rail and a sliding base, a plurality of sliding blocks 210 are disposed on the bottom of the first support structure 23 to serve as the sliding base, and a plurality of sliding rails 211 correspondingly engaged to the sliding blocks 210 are disposed on the first base platform 21 to serve as the guiding rail; and in an embodiment, two sliding blocks 210 and two sliding rails 211 are provided, thus allowing the sliding blocks 210 to move linearly along the sliding rails 211. As such, the driving member 27 can simultaneously drive the first support structure 23, the two carrying frames 24 on the first support structure 23, and the two first servo motors 26 and the two first milling tools 20 fastened on the carrying frames 24 to displace a certain distance (greater than or equal to the width d of the foot bases 90) relative to the first base platform 21 so as to process the end surfaces 9d of the four foot bases 90 and achieve the required height of the elevated floor.

The edge milling device 3 actuates in cooperation with the transport device 1a to process the flange 91 of the target object 9. For example, the edge milling device 3 is used to remove the burrs on the four sides around the elevated floor so as to process the four edge dimensions of the elevated floor. For instance, by using a man-machine control interface, machining values are inputted via a programmable logic controller (PLC) so as to control the four edge dimensions of the elevated floor to be processed.

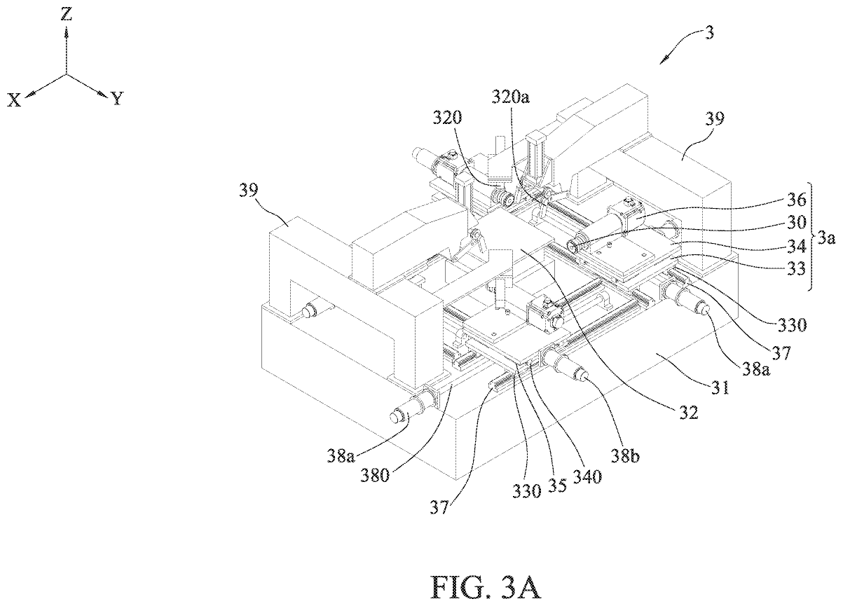

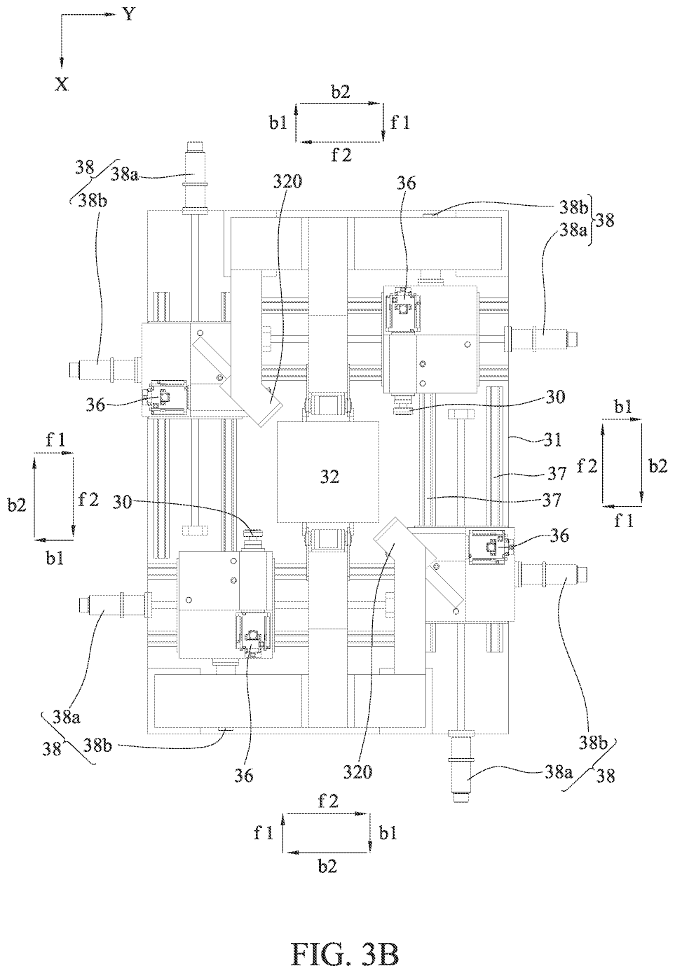

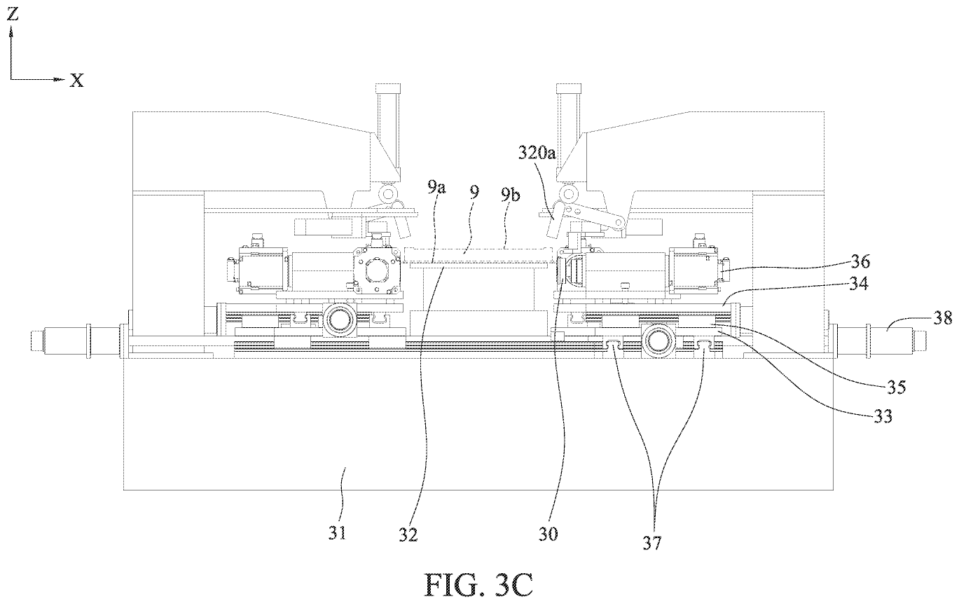

In an embodiment, referring to FIGS. 3A, 3B and 3C, the edge milling device 3 includes at least an edge milling component 3a, a second base platform 31 for disposing the edge milling component 3a, and a second positioning member 32 disposed at the center of the second base platform 31 for placing the target object 9. As such, the picking and placing component 10 can place the target object 9 on the second positioning member 32 so as for the edge milling component 3a to displace relative to the second positioning member 32 and perform an edge milling machining on the target object 9. For example, the second positioning member 32 is a square-shaped placing platform, and the elevated floor is placed on the placing platform. Four edge milling components 3a are disposed on four sides of the second positioning member 32 and displace relative to the second positioning member 32 for performing an edge milling machining on the target object 9. Further, according to the requirement, a plurality of fastening portions 320, 320a can be disposed at an outer side of the placing platform so as to press the target object 9 on the second positioning member 32, thus limiting the displacement of the target object 9 and avoiding deviation. For instance, support frames 39 are disposed on the front and rear sides of the second base platform 31 and the fastening portions 320 are disposed over the support frames 39. As such, after the target object 9 is placed on the placing platform, the foot bases 90 of the target object 9 are tightly held diagonally by the fastening portions 320, thus preventing the target object 9 from deviating during an edge milling machining Alternatively, the fastening portions 320a can be disposed over the placing platform. When the fastening portions 320a are pressed down or pulled up via a retractable operation actuated by power, the fastening portions 320a can press or separate from the second surface 9b of the target object 9.

Further, each of the edge milling component 3a includes a second milling tool 30, a second support structure 33 disposed on the second base platform 31, a frame base 34 disposed on the second support structure 33 for carrying the second milling tool 30, and a second servo motor 36 (e.g., the second servo motor 36 may be used as a motor) disposed on the frame base 34 for actuating the second milling tool 30. The frame base 34 is displaceably disposed on the second support structure 33 so as to move close to or away from the target object 9 along with the second milling tool 30. As such, the second milling tool 30 can be displaced to the required position to perform an edge milling machining on the target object 9. For example, for a combination of guiding rail and sliding base, a rail 35 is disposed on an upper side of the second support structure 33 and a sliding block 340 is disposed on a lower side of the frame base 34 to cooperate (e.g., engage) with the rail 35, thus allowing the second milling tool 30 to displace linearly (in a short distance) to the required machining position. For instance, the frame base 34 is configured with the second milling tool 30 and the second servo motor 36 actuating the second milling tool 30 to rotate. As such, at a target position (e.g., the flange 91 attached to the side surface 9c of the target object 9), the second milling tool 30 removes the burrs of the flange 91 of the target object 9.

Further, the second support structure 33 is a plate base body, which is displaceably disposed on the second base platform 31. For example, the second base platform 31 further has a position limiter 37 for limiting the displacement direction of the second support structure 33 and a power unit 38 for bringing (e.g., driving) the second support structure 33 and the frame base 34 to displace, as shown in FIG. 3B. For instance, for a combination of guiding rail and sliding base, the position limiter 37 is a double rail structure fastened on the second base platform 31, a sliding base 330 is fastened on the bottom of the second support structure 33, and a ball nut (not shown) and a ball screw rod 380 engaged with the ball nut are fastened at the bottom of the second support structure 33. The power unit 38 includes a first motor 38a, which drives the ball screw rod 380 to rotate and the ball nut to move linearly. Therefore, the second support structure 33 can be linearly displaced a long distance along the edge of the second positioning member 32 relative to the second base platform 31, and hence the second milling tool 30 can be linearly displaced a long distance along the side surface 9c of the target object 9 so as to process the flange 91 of the target object 9.

Furthermore, the power unit 38 further includes a second motor 38b, a rail 35 is fastened on the second support structure 33, and at least a sliding block 340 cooperated (e.g., engaged) with the rail 35 is fastened at the bottom of the frame base 34. The sliding block 340 can move on the rail 35 and thus the second motor 38b can drive the frame base 34 to displace linearly relative to the second support structure 33. Therefore, the second milling tool 30 can linearly displace to the required plane position so as to move close to or away from the second positioning member 32. For example, based on one side of the second positioning member 32, the displacement direction of the second support structure 33 (the movement directions f2, b2 as shown in FIG. 3B) and the displacement direction of the frame base 34 (the movement directions f1, b1 as shown in FIG. 3B) are perpendicular to one another. For instance, a ball nut (not shown) and a ball screw rod (not shown) engaged with the ball nut are fastened on the lower side of the frame base 34 and the second motor 38b can rotate the ball screw rod. Since the ball screw rod only rotates in place without moving, the ball nut is actuated by the ball screw rod to displace linearly. Hence, the ball nut linearly drives the frame base 34 to displace along the rail 35 and hence the second milling tool 30 is linearly displaced to the required machining position.

The flipping device 4 is disposed between the edge milling device 3 and the hole forming device 5 and actuates in cooperation with the transport device 1a to flip the first surface 9a or the second surface 9b of the target object 9. For example, after the burrs are removed, the elevated floor is flipped such that the first surface 9a thereof faces upward.

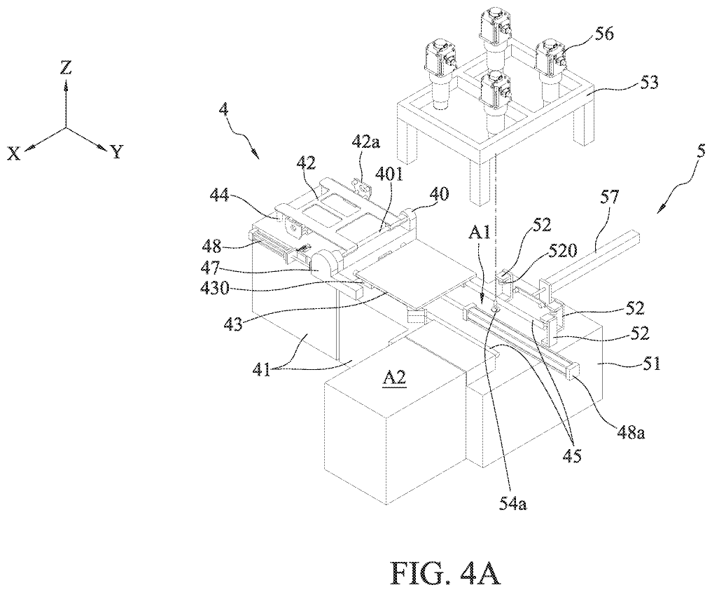

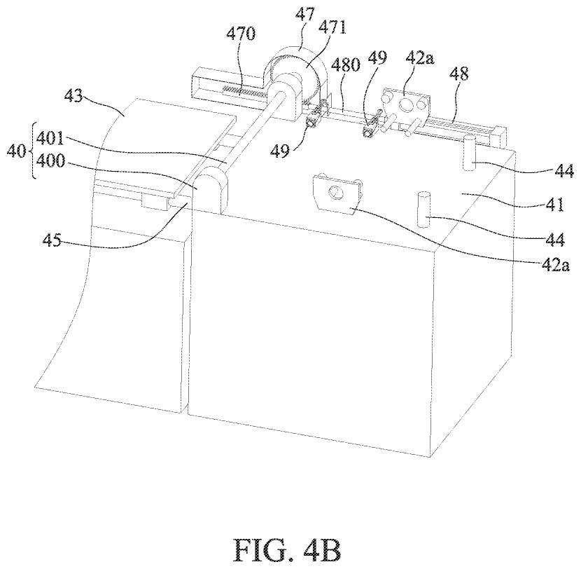

In an embodiment, referring to FIG. 4A or 4B, the flipping device 4 includes a third base platform 41, a shaft structure 40 disposed on the third base platform 41, a third positioning member 42 disposed on the third base platform 41, a third support structure 43 displaceably disposed on the third base platform 41, and a driving member 47 disposed on the third base platform 41. One end side of the third positioning member 42 is pivotally connected to the shaft structure 40 so as to flip relative to the third base platform 41, and the driving member 47 drives the third positioning member 42, such that the third positioning member 42 flips under force and positions over the third support structure 43. Therefore, after the target object 9 is placed on the third positioning member 42 by the picking and placing component 10, the target object 9 is transferred by the third positioning member 42 onto the third support structure 43.

Further, according to the requirement, at least a fastening structure 42a can be disposed at the front and rear sides of the third positioning member 42 to limit the displacement of the target object 9 and prevent the target object 9 from deviating from the third positioning member 42. Further, if needed, an abutting structure 44 can be disposed on the third base platform 41 to abut against the other end side of the third positioning member 42. For instance, the fastening structure 42a is pushed or pulled by a pneumatic cylinder (not shown) so as to engage with or separate from the third positioning member 42. As such, the fastening structure 42a abuts against or separates from the target object 9.

Furthermore, the third support structure 43 is a feeding plate, and a set of guiding rails 45 are disposed on the third base platform 41 corresponding to the third support structure 43, thus allowing the third support structure 43 to move between the third positioning member 42 and the hole forming device 5 along the guiding rails 45. For example, the bottom side of the third support structure 43 has a plurality of displacement portions 430 (e.g., sliding blocks) to engage with the guiding rails 45, thus allowing the third support structure 43 to move linearly along the guiding rails 45 and the third support structure 43 to move close to or away from the third positioning member 42. For instance, the third support structure 43 is pulled and driven by a pneumatic cylinder (not shown) to move linearly along the guiding rails 45.

In addition, the third positioning member 42 is a flipping plate, and the driving member 47 (as shown in FIG. 4A) is disposed on the front or rear side of the third base platform 41 so as to drive the third positioning member 42 to flip. For example, the driving member 47 includes a gear 471 and a rack 470 (as shown in FIG. 4B) engaging with the gear 471, and the gear 471 is axially connected to a shaft rod 401 of the shaft structure 40. Therefore, when the rack 470 moves linearly, the rack 470 will drive the gear 471 to rotate, so that the gear 471 rotates the shaft rod 401. As such, the third positioning member 42 is flipped and positioned over the third support structure 43. For instance, the rack 470 is linearly driven forward and backward by a push-pull rod 480 of the power unit 48 (e.g., a pneumatic or hydraulic cylinder), thus rotating the gear 471. At least a limit switch 49 can be disposed on the third base platform 41 to control the telescopic distance of the push-pull rod 480, so that the rotation amplitude of the gear 471 is driven by the rack 470, thereby stably flipping the third positioning member 42.

The hole forming device 5 actuates in cooperation with the flipping device 4 so as to form at least a hole 900 (counterbored hole as shown in FIG. 1D) on the first surface 9a of the target object 9. For example, a hole drilling machining is performed on the foot bases 90 of the elevated floor so as to form positioning holes of the elevated floor.

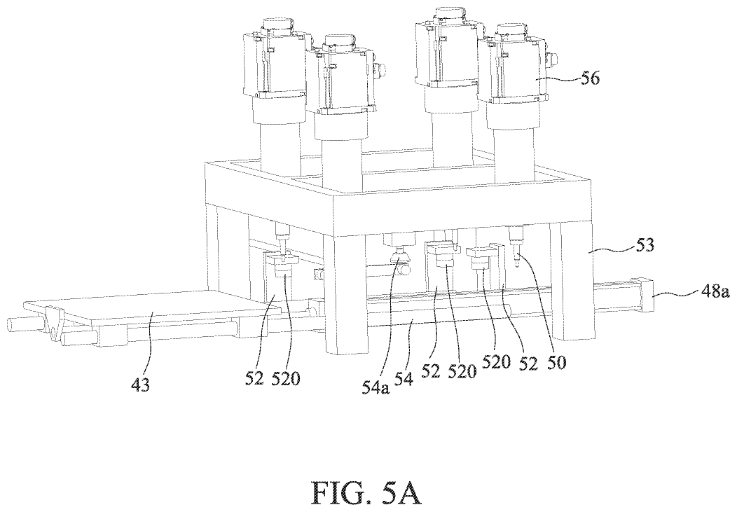

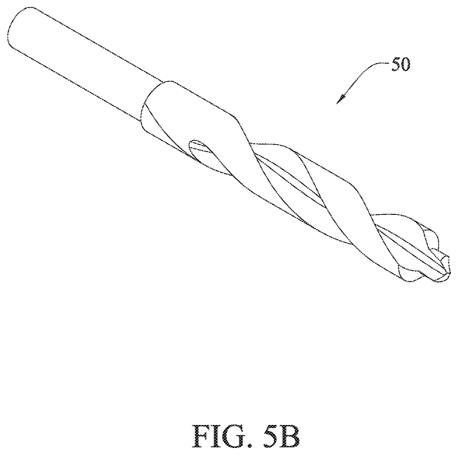

In an embodiment, the flipping device 4 and the hole forming device 5 are disposed at the same machining position, and the flipping device 4 and the hole forming device 5 cooperate with the same set of transport device 1a. Referring to FIGS. 4A and 5A, the hole forming device 5 includes a fourth base platform 51 adjacent to and connecting the third base platform 41, at least a fourth positioning member 52 disposed on the fourth base platform 51, a fourth support structure 53 disposed on the fourth base platform 51, at least a hole forming member 50 disposed on the fourth support structure 53 for performing hole forming machining on the target object 9, and at least a third servo motor 56 (e.g., the third servo motor 56 may be used as a motor) for rotating the hole forming member 50. Further, by arranging a pneumatic or hydraulic component (e.g., another power unit 48a), the third support structure 43 displaces relative to the third base platform 41 so as to transport the target object 9 onto the fourth base platform 51 and allow the hole forming member 50 to form holes 900 on the target object 9.

For example, the fourth base platform 51 and the third base platform 41 can be coplanar, and a machining area A1 and a discharging area A2 are defined on the fourth base platform 51. The fourth positioning member 52 is disposed at an edge of the machining area A1 to limit the target object 9 in the machining area A1, and the fourth support structure 53 covers over the machining area A1. The hole forming member 50 is displaceably disposed over the machining area A1 to perform a hole forming machining on the foot bases 90 of the target object 9, thereby completing drilling operation of counterbored holes required at the foot bases 90 of the target object 9. Further, the guiding rails 45 extend to the machining area A1 of the fourth base platform 51. For instance, after the third support structure 43 transports the elevated floor to the machining area A1 along the guiding rails 45, the fourth positioning member 52 limits the target object 9 so as to facilitate positioning of the target object 9 on the fourth base platform 51.

Further, the fourth positioning member 52 is arranged corresponding to an edge of the fourth base platform 51 so as to limit the displacement of the target object 9 and prevent the target object 9 from deviating in the machining area A1. For instance, according to the path direction of feeding (from the third base platform 41 to the machining area A1) or the guiding rails 45, the fourth positioning member 52 is disposed at the end of the feeding path, for example, rear and right sides of the machining area A1, thereby achieving the purpose of limiting the displacement of the feeding plate. For example, a buffer member 520, such as a runner (e.g., rotating wheel), a bearing or the like, is disposed on the top end of the fourth positioning member 52 so as to contact the target object 9 in a smooth sliding manner. Therefore, the feeding plate and the target object 9 thereon can smoothly enter the machining area A1 (e.g., without being jammed) with reduced friction.

Furthermore, the fourth support structure 53 is a frame body, which corresponds to the range of the machining area A1 and covers over the machining area A1. According to the requirement, at least a third servo motor 56 can be provided to actuate the hole forming member 50 (as shown in FIG. 5A). For example, the third servo motor 56 drives the hole forming member 50 to vertically lift (or descend) and rotate simultaneously, thereby performing a hole drilling machining on the foot base 90 of the elevated floor so as to form a counterbored hole. The hole forming member 50 is of a step drill type (as shown in FIG. 5B), which is disposed at corners of the fourth support structure 53. The structure of the fourth support structure 53 and the arrangement of the third servo motor 56 and the hole forming member 50 can be designed according to the requirement, and the present disclosure is not limited as such.

In addition, a fastening structure 54a can be disposed corresponding to the fourth positioning member 52 and abut against the target object 9. For example, the fastening structure 54a is such as a physically pressing head or a vacuum adsorption head disposed on the lower side of the fourth support structure 53. As such, the fastening structure 54a can be driven by a pneumatic or hydraulic component (not shown) to press the target object 9. An actuating member 57 with a rake-shaped front end is disposed at the machining area A1 in the direction corresponding to the discharging area A2. The actuating member 57 is a retractable structure, which pushes the side surface 9c of the target object 9 in the machining area A1 via a pneumatic or hydraulic component (not shown). Therefore, after the target object 9 is processed in the machining area A1, the target object 9 is displaced under force to the discharging area A2.

When the machining apparatus 1 is used on the production line, one picking and placing component 10 of the transport device 1a transports a single target object 9 to the height milling device 2, so that the height milling device 2 performs a height milling operation (i.e., burr milling) on the foot bases 90 of the target object 9. After the height milling operation is completed, another picking and placing component 10 of the transport device 1a transports the target object 9 from the height milling device 2 to the edge milling device 3 for edge milling operation, where the edge milling device 3 mills the burrs on the flange 91 of the four side surfaces 9c of the target object 9.

In an embodiment, by the design of a loop-type displacement of the edge milling component 3a of the edge milling device 3 (in the movement directions f1, f2, b1, b2 of FIG. 3B), the edge milling component 3a is prevented from repeatedly milling the flange 91 on the same side surface 9c, thus avoiding excessive milling of the flange 91 on the side surface 9c of the target object 9 that otherwise may damage the edge milling component 3a or induce mechanical noise.

Since the early milling operation is performed on the bottom of the elevated floor (the second surface 9b of the target object 9) and a later hole drilling operation is to be performed on the top surface of the elevated floor (the first surface 9a of the target object 9), it is necessary to flip the elevated floor before the hole drilling operation. Therefore, the target object 9 is transported from the edge milling device 3 to the third positioning member 42 of the flipping device 4 via another picking and placing component 10 of the transport device 1a. Then, the driving member 47 rotates the shaft structure 40 to flip the third positioning member 42 along the shaft structure 40. As such, the target object 9 is flipped 180 degrees and placed on the third support structure 43. Thereafter, the third support structure 43 is slid into the machining area A1 of the hole forming device 5 by the guiding rails 45. It should be understood that the target object 9 can also be flipped manually.

Finally, drilling operation of counterbored holes required at the foot bases 90 of the target object 9 (holes 900 as shown in FIG. 1D) is carried out by the hole forming device 5, and after the hole drilling operation is completed, the target object 8 (as shown in FIG. 1D) that has finished machining is pushed by the actuating member 57 to the discharging area A2 so as to complete machining of the elevated floor.

In summary, in the machining apparatus 1 according to the present disclosure, the first servo motor 26 and the first milling tool 20 are integrated in a linear manner to reduce the volume, the second servo motor 36 and the second milling tool 30 are integrated in a linear manner to reduce the volume of the frame base 34, and the third servo motor 56 and the hole forming member 50 are integrated in a linear manner to reduce the volume. Therefore, on a single production line, a height milling machining can be performed on the foot bases 90 and an edge milling machining and a hole forming machining can be performed on the flange 91 for the elevated floor so as to speed up the production, improve the production efficiency and reduce the labor cost. The present disclosure is characterized in that the first to third servo motors 26, 36, 56 directly drive the first milling tool 20, the second milling tool 30 and the hole forming member 50 to rotate, which not only reduces the volume of the height milling device 2, the edge milling device 3 and the hole forming member 50, but also improves the machining precision and the machining speed via digital control of rotation of the first to third servo motors 26, 36, 56. The conventional motor driving of the prior art cannot achieve such an efficiency.

The above-described descriptions of the detailed embodiments are to illustrate the implementation according to the present disclosure, and it is not to limit the scope of the present disclosure. Accordingly, all modifications and variations completed by those with ordinary skill in the art should fall within the scope of present disclosure defined by the appended claims.

What is claimed is:

1. A machining apparatus, comprising:
a transport device for moving a target object, wherein the target object has a first surface, a second surface opposite to the first surface, a side surface adjacent to and connecting the first surface and the second surface, and a flange protruding from the side surface, and four corners of the second surface have four foot bases;
a height milling device actuating in cooperation with the transport device for machining end surfaces of the foot bases of the target object, wherein the height milling device comprises a height milling component comprising at least one first milling tool, a first motor directly driving the first milling tool, at least one first support structure having sliding rails disposed on surfaces of two opposite sides thereof, at least one carrying frame symmetrically disposed on the two opposite sides of the first support structure, and at least one adjustment member, wherein the first motor and the first milling tool are disposed on one side of the carrying frame and a sliding base engaged with the sliding rails is disposed on another side of the carrying frame, wherein the adjustment member drives the first milling tool on the carrying frame to move linearly up and down along the sliding rails to reach a height required to process the foot bases, and wherein the first motor and the first milling tool are integrated in a linear manner;
an edge milling device actuating in cooperation with the transport device for machining the flange of the target object, wherein the edge milling device comprises an edge milling component comprising a second milling tool, a second support structure for driving the second milling tool to displace linearly, a frame base displaceably disposed on the second support structure for carrying the second milling tool, and a second motor disposed on the frame base for directly driving the second milling tool to cause the frame base and the second milling tool to move close to or away from the target object, thereby allowing the second milling tool to perform an edge milling machining on the target object, wherein the second support structure is a plate base body, and wherein the second motor and the second milling tool are integrated in a linear manner; and
a hole forming device for forming holes on the four foot bases of the target object, wherein the hole forming device comprises at least one hole forming member for performing a hole forming machining on the target object, and at least one third motor for rotating the hole forming component, and wherein the third motor and the hole forming member are integrated in a linear manner.

2. The machining apparatus of claim 1, wherein the transport device comprises a support component and at least one picking and placing component displaceably disposed on the support component and cooperating with the support component to move the target object, thereby picking an placing the target object.

3. The machining apparatus of claim 1, wherein the carrying frame is an L-shaped frame body symmetrically disposed on the two opposite sides of the first support structure, and wherein the first milling tool and the first motor are disposed on the side of the carrying frame facing the target object in a manner that the first milling tool on the carrying frame moves linearly up and down along the sliding rails.

4. The machining apparatus of claim 1, wherein the height milling device further comprises:
a first base platform for disposing the height milling component;
a first positioning member disposed on and in parallel to the first base platform for carrying the target object and limiting displacement of the target object;
a fastening portion correspondingly disposed at two opposite sides of the first positioning member for pressing the target object on the first positioning member; and
a driving member for driving the first support structure to displace, thereby driving the height milling component to move linearly to perform a height milling machining on the target object.

5. The machining apparatus of claim 1, wherein the second support structure has a displacement direction perpendicular to a displacement direction of the frame base.

6. The machining apparatus of claim 1, wherein the second support structure has a rail, and the frame base has at least one sliding block cooperated with the rail, and wherein the sliding block moves along the rail to cause the frame base to displace relative to the second support structure.

7. The machining apparatus of claim 1, wherein the edge milling device further comprises:
a second base platform for displaceably disposing the edge milling component thereon, wherein the second support structure is displaceably disposed on the second base platform;
a second positioning member disposed on the second base platform for placing the target object, wherein the edge milling component is disposed at a side of the second positioning member to displace relative to the second positioning member and perform the edge milling machining on the target object; and
a fastening portion disposed corresponding to the second positioning member for pressing the target object on the second positioning member.

8. The machining apparatus of claim 1, wherein the hole forming member is of a step drill type.

9. The machining apparatus of claim 1, wherein the hole forming device further comprises:
a base platform defined with a machining area and a discharging area, wherein the hole forming member is displaceably disposed on the machining area to perform a hole forming machining on the foot bases of the target object, thereby completing drilling operation of counterbored holes required at the foot bases of the target object;
a positioning member disposed on the machining area of the base platform for limiting the target object in the machining area; and
a fastening structure arranged corresponding to the positioning member to contact and abut against the target object on the base platform.

10. The machining apparatus of claim 1, further comprising a flipping device disposed between the edge milling device and the hole forming device for flipping the first surface or the second surface of the target object, wherein the flipping device comprises a base platform, a shaft structure disposed on the base platform, a positioning member disposed on the base platform, a third support structure displaceably disposed on the base platform, and a driving member disposed on the base platform, and wherein one end of the positioning member is pivotally connected to the shaft structure to flip relative to the base platform, and the driving member drives the positioning member, such that the positioning member flips under force over the third support structure.
